(19) United States
(12) Patent Application Publication
(10) Pub. No.: US 2006/0120354 A1
(43) Pub. Date: Jun. 8, 2006

(54) Switching apparatus for supporting protection switch-over mode of SONET/SDH network and method thereof

(76) Inventors: Jong-Moo Sohn, Daejon (KR); Jeong-Hee Lee, Daejon (KR)

Correspondence Address: LADAS & PARRY LLP, 224 SOUTH MICHIGAN AVENUE, SUITE 1600, CHICAGO, IL, 60604, US

(21) Appl. No.: 11/183,712

(22) Filed: Jul. 18, 2005

(30) Foreign Application Priority Data
Dec. 6, 2004 (KR) 10-2004-0101841
May 4, 2005 (KR) 10-2005-0037755

(51) Int. Cl. H04L 12/66

(52) U.S. Cl. 370/352

(57) ABSTRACT

An integrated switching apparatus for supporting a protection switch-over mode of a circuit-switched network and a method thereof are disclosed. The integrated switching apparatus includes: a plurality of input circuit data processing unit for converting externally received circuit data to fixed length packets; a plurality of input packet data processing unit for converting externally received packet data to fixed length packets; a fixed length packet switching unit for switching the fixed length packets to a destination output port; a plurality of output circuit data processing unit for restoring and outputting circuit data by converting the fixed length packets according to a protection switch-over mode; a plurality of output packet data processing unit for restoring and outputting the fixed packet transferred from the fixed length packet switching unit according to a protection switch-over mode; and a control/timing unit for collecting state information and distributing the collected state information.

### FIELD OF THE INVENTION

The present invention relates to an integrated switching apparatus for supporting a protection switch-over mode of a circuit-switched network and a method thereof; and, more particularly, to an integrated switching apparatus for supporting a protection switch-over mode of SONET/SDH network by using a fixed-length packet switch of a general packet network (IP/Ethernet) and a method thereof.

### DESCRIPTION OF RELATED ARTS

A synchronous optical network (SONET)/synchronous digital hierarchy (SDH) network provides a highly reliable circuit switching function as a transport network. Data is transmitted and switched through a fixed path with a fixed bandwidth in the SONET/SDH network. Accordingly, the SONET/SDH network is advantageous network in a view of reliability and usability. However, the SONET/SDH network has drawbacks such as low bandwidth-utilization ratio and high cost per leased line.

An Internet protocol (IP) network or an asynchronous transfer mode (ATM) network provides a switching function by using statistical multiplexing characteristics without using a fixed path and a fixed bandwidth. Therefore, the IP network or the ATM network provides high bandwidth utilization ratio and low cost service. However, data may be lost in the IP network or the ATM network when data traffic is burst or congested.

If data traffic of a conventional SONET/SDH network is accommodated by using the IP network in a network environment formed with the networks having different characteristics as described above, a network system operator can provide various services using single network and control the single network with single maintenance system.

In order to accommodate the data traffic of the conventional SONET/SDH network using the IP network, there are various methods introduced for gradually transforming the SONET/SDH network to a packet network by emulating a circuit network through the IP/Ethernet network which is a packet network, or by using an integrated switching apparatus that simultaneously accommodates data traffics of the SONET/SDH network and the packet network while maintaining both networks.

A circuit emulation over packet network (CEP) scheme is a representative technique of emulating the circuit network through the packet network, and is standardized in an Internet engineering task force (IETF). However, the CEP scheme requires a complicated transformation and an additional timing recovery function in order to maintain a circuit switching characteristic in a packet network. Therefore, an entire performance of network may depend on a performance of a protocol processor rather than a switching apparatus.

Meanwhile, another conventional switching method transforming IP/Ethernet data to time division mode (TDM) data is introduced as a method for accommodating data traffic of the SONNET/SDH using the IP/Ethernet network. The conventional switching method provides a connection-based switching function, which is required by the TDM data, by using a circuit switch simultaneously accommodating the SONET/SDH network and the IP/Ethernet network as an integrated switching apparatus.

Since the conventional switching method transforms IP/Ethernet data to the TDM data type, it is difficult to control a bandwidth allocation, and a bandwidth of entire switch may be insufficiently utilized. Furthermore, the switching efficiency is also dropped when the number of switching ports or ports using the IP/Ethernet data is increased. Therefore, it is difficult to embody a mass capacity switching system based on the conventional switching method.

As another method accommodating data traffic of the SONET/SDH network using the IP/Ethernet network, there is further another conventional switching method introduced. The conventional switching method transforms TDM data and IP/Ethernet data to an asynchronous transfer mode (ATM) data type. This conventional switching method uses an ATM switch as an integrated switching apparatus for simultaneously accommodating the SONET/SDH network and the IP/Ethernet network. The conventional switching method may provide distinct service based on the ATM characteristics. However, it is very difficult to control because additional connection setting must be performed for the IP/Ethernet data which is not connection-based. Also, implementation complexity is increased according to a capacity of the switch. Therefore, it is hard to embody a mass capacity switching system based on the conventional switching method.

Moreover, the conventional switching methods processing the time division multiplex (TDM) data using a predetermined protocol are not suitable for networks using various protection switch-over functions such as 1+1 or uni-directional path switched ring (UPSR), which is provided in the SONET/SDH network.

Therefore, there is great demand for an integrated switching method providing high flexibility, low implementation cost, and easy extendibility.

### SUMMARY OF THE INVENTION

It is, therefore, an object of the present invention to provide a switching apparatus for supporting a protection switch-over mode of a SONET/SDH network by using a fixed length packet switch of a packet network such as IP/Ethernet network, and a method thereof.

In accordance with an aspect of the present invention, there is provided an integrated switching apparatus supporting a protection switch-over function of a circuit-switched network, the integrated switching apparatus including: a plurality of input circuit data processing unit for converting externally received circuit data to fixed length packets, and forming a pair in order to output the packet according to the protection switch-over mode; a plurality of input packet data processing unit for converting externally received packet data to fixed length packets, and outputting the packet according to the protection switch-over mode; a fixed length packet switching unit for switching the fixed length packets transferred from the input circuit data processing unit and the input packet data processing unit to a destination output port; a plurality of output circuit data processing unit for restoring circuit data by converting the fixed length packets transferred from the fixed length packet switching means, and forming a pair for outputting the restored circuit data according a protection switch-over mode; a plurality of output packet data processing unit for restoring and outputting packet data by converting the fixed length packets transferred from the fixed length packet switching unit according to a protection switch-over mode; and a control/timing unit for collecting state information from the input circuit data processing means, the input packet data processing means, the fixed length packet switching means, the output circuit data processing means, and the output packet data processing means, and distributing the collected state information in order to switch the externally received circuit data and packet data according to a protection switch-over mode.

In accordance with another aspect of the present invention, there is provided an integrated switching method supporting a protection switch-over mode of a circuit-switched network, the integrated switching method including the steps of: a) converting input circuit data to fixed length packets; b) converting input packet data to fixed length packets; c) switching the converted fixed length packets to a destination output port based on a protection switch-over mode; d) restoring circuit data of a connected network by converting the switched fixed length packets and outputting the restored circuit data based on a protection switch-over mode; and e) restoring packet data of a connected network by converting the switched fixed length packets and outputting the restored packet data based on a protection switch-over mode.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram illustrating an integrated switching apparatus supporting a protection switch-over mode of a circuit-switched network in accordance with a preferred embodiment of the present invention;

FIG. 2 is a block diagram showing an input TDM data processor in an integrated switching apparatus supporting a protection switch-over mode of a circuit-switched network in accordance with a preferred embodiment of the present invention;

FIG. 3 is a block diagram depicting an input IP data processor in an integrated switching apparatus supporting a protection switch-over mode of a circuit-switched network in accordance with a preferred embodiment of the present invention;

FIG. 4 is an output TDM data processor in an integrated switching apparatus supporting a protection switch-over mode of a circuit-switched network in accordance with a preferred embodiment of the present invention;

FIG. 5 is a diagram showing a structure of a lookup table in accordance with a preferred embodiment of the present invention;

FIG. 6 is a flowchart showing operations of an input TSI processor in an integrated switching apparatus supporting a protection switch-over mode of a circuit-switched network in accordance with a preferred embodiment of the present invention;

FIG. 7 is a flowchart showing operations of the packet generator in an integrated switching apparatus supporting a protection switch-over mode of a circuit-switched network in accordance with a preferred embodiment of the present invention; and

FIG. 8 is a flowchart showing operations of an output TDM processor in an integrated switching apparatus supporting a protection switch-over mode of a circuit-switched network in accordance with a preferred embodiment of the present invention.

### DETAILED DESCRIPTION OF THE INVENTION

Hereinafter, a switching apparatus for supporting a protection switch-over mode of SONET/SDH network, and a method thereof in accordance with a preferred embodiment of the present invention will be described in more detail with reference to the accompanying drawings.

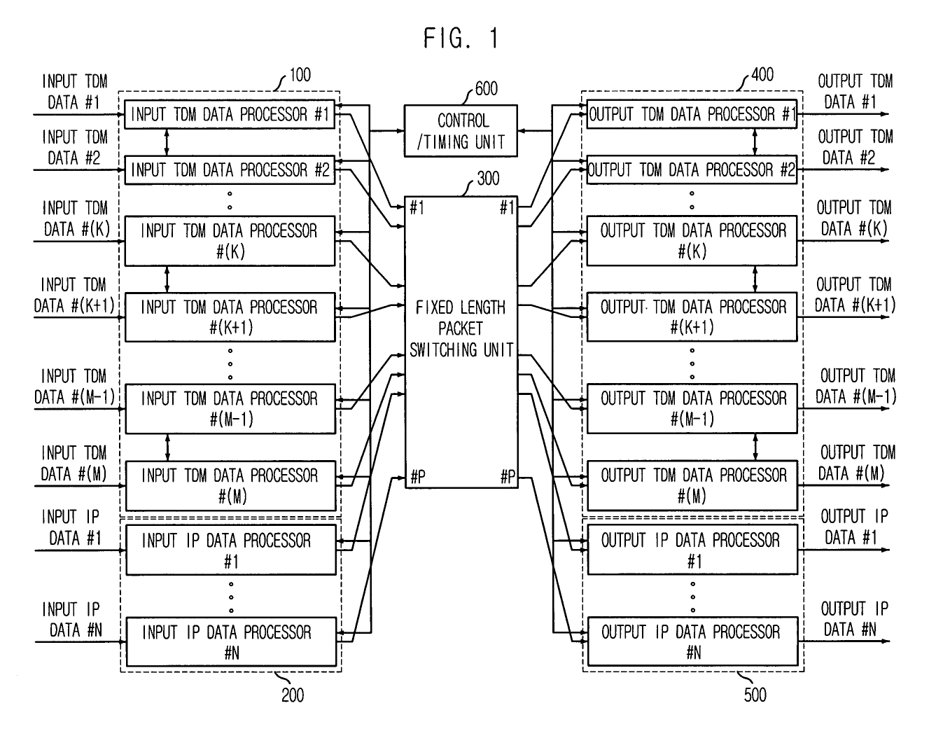

FIG. 1 is a diagram illustrating an integrated switching apparatus supporting a protection switch-over mode of a circuit-switched network in accordance with a preferred embodiment of the present invention. The present invention will be explained with a present embodiment includes an input IP data processor 200 and an output IP data processor 500 for processing input IP data and an output IP data. However, the integrated switching apparatus according to the present invention may process another packet data including an Ethernet frame.

As shown in FIG. 1, the integrated switching apparatus supporting a protection switch-over mode of a circuit-switched network includes an input TDM data processing unit 100 including M input TDM data processors, where M is an even integer number larger than 2, an input IP data processing unit 200 including N input IP data processors, where N is a positive integer larger than 1, a fixed length packet switching unit 300 having P ports, where P is a positive integer larger than M+N, an output TDM data processing unit 400 including M output TDM data processors, an output IP data processing unit 500 including N output IP data processors, and a control/timing unit 600.

Two of input/output TDM data processors among M input/output TDM data processors are formed a pair as a basic unit to perform a protection switch-over function, and the pair of the input/output TDM data processors can be connected to different types of SONET/SDH networks requiring distinct protection switch-over functions.

For example, the input/output TDM data processors #1 and #2 may be formed as a pair for 1+1 protection switch-over, the input/output TDM data processors #(k) and #(k+1) are formed as a pair for uni-directional path switched ring (UPSR), and the input/output TDM data processor #(M-1) and #(M) may be formed as a pair for bi-directional line switched ring (BLSR).

Each of the input/output TDM data processors for 1+1 protection switch-over operates in a ‘work’ mode and a ‘protect’ mode, and the both of the input/output TDM data processors forming a pair for 1+1 protection switch-over cannot be in the same mode. And, each of the input/output TDM data processors for UPSR or BLSR is connected to an east ring and a west ring.

Operation modes of the input/output TDM data processors are detected and collected by the control/timing unit 600 as soon as each input/output TDM data processor is installed, and the collected operation mode information of each input/output TDM data processor is distributed to each of the input/output TDM data processors to be used for protection switch-over function.

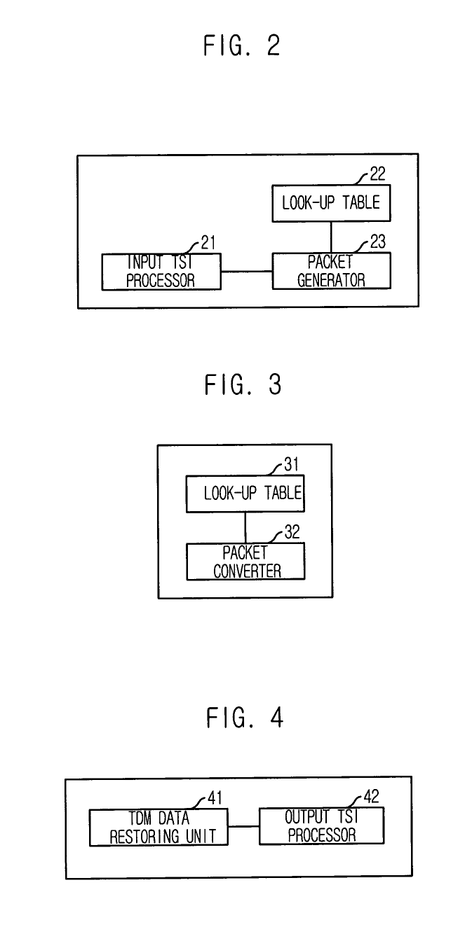

Hereinafter, each of constituent elements will be explained with reference to FIGS. 2 to 4 in detail.

FIG. 2 is a block diagram showing an input TDM data processor in an integrated switching apparatus supporting a protection switch-over mode of a circuit-switched network in accordance with a preferred embodiment of the present invention.

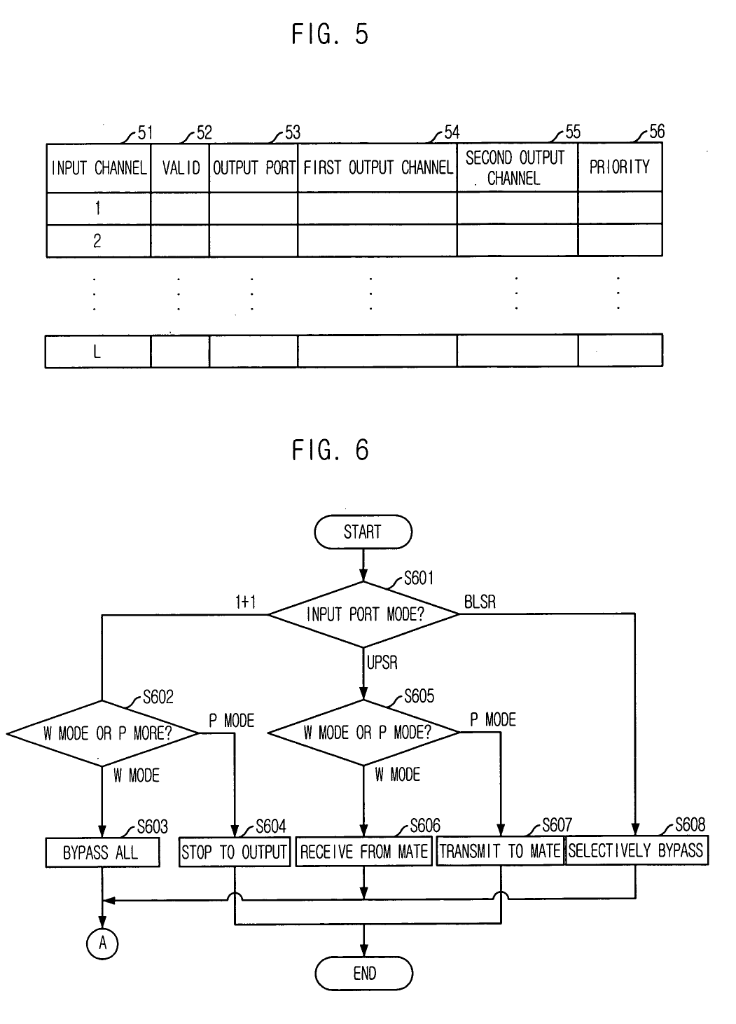

The input TDM data processing unit 100 includes a plurality of input TDM data processors. As shown in FIG. 2, each input TDM data processor includes an input TSI processor 21 for time-slot interchanging inputted TDM data according to a predetermined value, and outputting the interchanged data according to TDM channel, where the time-slot interchange (TSI) is exchange of a time slot in a TDM frame; a look-up table for storing information to generate a packet according to TDM channel and information about mounting state and operation mode of each input/output TDM processor; and a packet generator 23 for converting TDM channel data outputted from the input TSI processor 21 to fixed length packets. Herein, two input TDM data processors are formed as a pair to perform the protection switch-over function. Forming the pair and performing the protection switch-over function will be explained in later with reference to FIG. 5.

The input TSI processor 21 selects TDM data according to an operation mode and TDM channel state information of the input TDM data processor where the input TSI processor belongs to. The input TSI processor 21 may bypass all of TDM channel data inputted from a SONET/SDH network to the packet generator 23 without modifying the TDM channel data.

The input TSI processor 21 may bypass all of TDM channel data transferred from a mate input TDM data processor to the packet generator 23 without modifying the TDM data. The mate input TDM data processor is another TDM data processor connected to an input TDM data processor to form a pair for the protection switch-over function.

The input TSI processor 21 may receive TDM channel data from the SONET/SDH network or from the mate input TDM data processor according to a state of TDM data channel inputted from the SONET/SDH network, and transfer the received TDM channel data to the packet generator 23. The above described operations of the input TSI processor are performed according to information received from the control/timing unit 600 and the mounting state information of the mate input TDM data processor.

The packet generator 23 generates fixed length packets according to each channel by converting the received TDM channel data, and outputs the fixed length packet. In order to generate the packet, the packet generator 23 references to the look-up table 22 based on an input TDM channel number. As a result of referencing the look-up table 22, the packet generator 23 obtains information about an output port, validity, an output channel, and a priority, to output corresponding TDM channel data.

That is, the packet generator 23 generates a packet header by using the obtained information from the look-up table 22, and generates a fixed length packet by converting the TDM channel data transferred from the input TSI processor 21. The packet generator 23 changes an output port number or an output channel number in a fixed length packet header according to installation information of an output port and an operation mode of an output port for smoothly performing a switching operation when the protection switch-over is performed caused by malfunctioning of one of input/output data processors. The above described operations are performed through the received information from the control/timing unit 600.

The lookup table 22 stores information, i.e., an input TDM channel number, validity information, an output port number, an output channel number and a priority, to be correspondent to each input TDM channel number. The lookup table 22 transfers the stored information corresponding to an input TDM channel number to the packet generator 23 by a request. Information stored in the lookup table 22 is set by the control/timing unit 600. A structure of the lookup table 22 will be explained in detail with reference to the FIG. 5.

FIG. 5 is a diagram showing a structure of a lookup table in accordance with a preferred embodiment of the present invention.

The lookup table 22 according to the present embodiment stores various information to switch a packet generated by converting an input TDM channel data. As shown in FIG. 5, the lookup table 22 includes an input TDM channel number field 51 for storing an input TDM channel number and header information fields for storing header information of a packet which is required to convert the TDM channel data to a packet. The header information fields include a validity field 52 storing validity of TDM channel, an output port field 53 for storing information about an output switch port number, first and second output channel fields 54, 55 for storing information output TDM channel numbers and a priority field 56 for storing information about a priority. Label type ID may be included in the look-up table 22.

The validity field 52 represents whether an input TDM channel is valid or not. An input TDM channel referenced by the validity field representing as valid is used when generating a packet, and input TDM channels referenced by the validity field representing as invalid are eliminated at the packet generator 23.

The output port field 53 denotes an output port of a fixed length packet switching unit 300.

The first output channel field 54 represents a channel number used when an output port is in normal state, and the second output channel field 55 denotes a channel number alternatively used when an output port number is changed by the protection switch-over at an output port in the BLSR mode.

The priority field 56 represents a relative priority in a fixed length switching unit 300.

The information stored in the look-up table 22 is set, maintained and managed by the control/timing unit 600.

The input IP data processing unit 200 includes a plurality of input IP data processors. Each input IP data processor, as shown in FIG. 3, includes a look-up table 31 for storing information for generating a fixed length packet by converting externally inputted IP data; and a packet converter 32 for converting the IP data to the fixed length packet by reference to the look-up table 31. The input IP data processor externally receives IP data, and analyzes information about an output port and a priority corresponding to the fixed length packet switching unit 300. According to the analyzed information, the input IP data processor converts the received IP data to a packet to be recognized by the fixed length packet switching unit 300, and outputs the packet.

In order to convert the IP data to the packet, the input IP data processor includes: a look-up table 31 storing fixed length packet generation information including validity of a packet, an output port number, an output channel number and a priority; and a packet converter 32 for generating a fixed length packet by converting the received IP data with reference to the look-up tale 31, and changing an output port number or an output channel number of a packet header generated according to output port mounting state information and output port operation mode. Such operations are controlled by the control/timing unit 600.

The fixed length packet switching unit 300 queues the fixed length packets from each input TDM data processor and each input IP data processor at a virtual output buffer, and perform a switching operation by scheduling the packets queued in the virtual output buffer.

The output TDM data processing unit 400 includes a plurality of output TDM data processors. As shown in FIG. 4, each output TDM data processor includes: a TDM data restoring unit 41 for restoring a packet data switched from the fixed length packet switching unit 300 to TDM channel data; and an output TSI processor 42 for time-slot interchanging the restored TDM channel data according to predetermined value and outputting the interchanged TDM channel data.

The TDM data restoring unit 41 receives a packet data from the fixed length packet switching unit 300, analyzes the packet data, and restores TDM data according to an output TDM channel number. The TDM data restoring unit 41 inspects the restored TDM data, destroys all TDM data having errors, and transfers TDM data having no error to the out TSI processor 42. Also, all of the restored TDM data may be destroyed according to an operation mode of the output TDM data processor and a state of a mate output TDM data processor.

The output TSI processor 42 performs a time-slot interchange (TSI) on the restored TDM data according to a control of the control/timing unit 600, and outputs the interchanged TDM data according to each TDM channel. The output TSI processor 42 may simultaneously output TDM data to the SONET/SDH network and to the mate output TDM data processor by copying the TDM data according to an operation mode of the output TDM processor.

The output TSI processor 42 may output TDM data received from the mate output TDM data processor to the SONET/SDH network. Also, the output TSI processor 42 outputs all of the TDM channel data received from the TDM data restoring unit 41 to the SONET/SDH network without modification.

The output IP data processing unit 500 includes a plurality of output IP data processors. Each output IP data processor receives a packet data switched at the fixed length packet switching unit 300 and restores IP data by converting the packet data.

The control/timing unit 600 controls each of the constituent elements of a time division multiplex (TDM)/Internet protocol (IP) integrated switching apparatus, and generates a signal to synchronize the constituent elements.

That is, the control/timing unit 600 controls the input TSI processor, the output TSI processor, the input IP processor, and the output IP processor, and sets an output port number and an output channel number to be matched each others. Also, the control/timing unit 600 collects installation information and operation mode information of each input/output processor, and re-distributes the collected information to the input/output processors. A function of the control/timing unit 600 will be explained in later.

Hereinafter, operations of the input TSI processor 21 will be explained with reference to FIG. 6.

FIG. 6 is a flowchart showing operations of an input TSI processor in an integrated switching apparatus supporting a protection switch-over mode of a circuit-switched network in accordance with a preferred embodiment of the present invention.

By referring to FIG. 6, the input TSI processor 21 inspects an operation mode for a protection switch-over of an input port according to a structure of a connected SONET/SDH network at step S601.

If the operation mode of an input TDM data processor where the input TSI processor 21 belongs to is a ‘1+1’, the input TSI processor 21 determines whether an own operation mode is a work mode or a protect mode at step S602. In the work mode (W mode), the input TDM data bypasses all TDM data to the switch. And, the input TDM data destroys all TDM data in the protect mode (P mode).

As a result of the determination, if the operation mode is the work mode, the input TDM data bypasses all TDM data to the packet generator 23 at step S603. If the operation mode is the protect mode, the input TDM data destroys all TDM data inputted from the network at step S604. Accordingly, the packet generator 23 will receive no data from the input TSI processor 21.

Meanwhile, if the operation of the input TDM data processor where the input TSI processor 21 belongs to is a UPSR mode at step S601, the input TSI processor 21 determines whether an own operation mode is a work mode or a protect mode at step S605.

If the own operation mode is the work mode at step S605, the TSI processor collects normal channels among TDM channel data inputted from the network and TDM channel data inputted from a mate input TSI processor, constructs all TDM channel data to be normal, and outputs the constructed TDM data to the packet generator 23 at step S606. For example, if there are four TDM channels A, B, C and D, and if there is an error in the B TDM channel, the input TSI processor 21 in the work mode dose not receive abnormal B channel data from the network. That is, the input TSI processor receives TDM channel data from the mate input TSI processor, and constructs TDM channel data with normal A, B, C and D channels. After constructing the TDM data with normal A, B, C and D channels, the constructed TDM data is outputted to the packet generator 23.

And, if the own operation mode is the protect mode at step S605, all of inputted TDM channel data are transferred to the mate input TSI processor at step S607, and no data is transferred to the packet generator of the own TDM data processor.

Meanwhile, if the operation mode of the input TDM data processor is “BLSR”, a mate communication between a pair of the input TSI processors is not used. Among the TDM channels inputted from the network and channels that are normal and selected by the control/timing unit 600 are transferred to the packet generator 23 at step S608.

The operation modes according to network connection of the input TDM data processors such as ‘1+1’, ‘UPSR’ or ‘BLSR’ may be set by using a hard-wired value or by the system operator to pass the data through the control/timing unit 600. And, the operation mode is set once at initialization according to a structure of the network. On contrary, the working mode or the protect mode can be set by the control/timing unit 600 or an automatic recognition of a hardware.

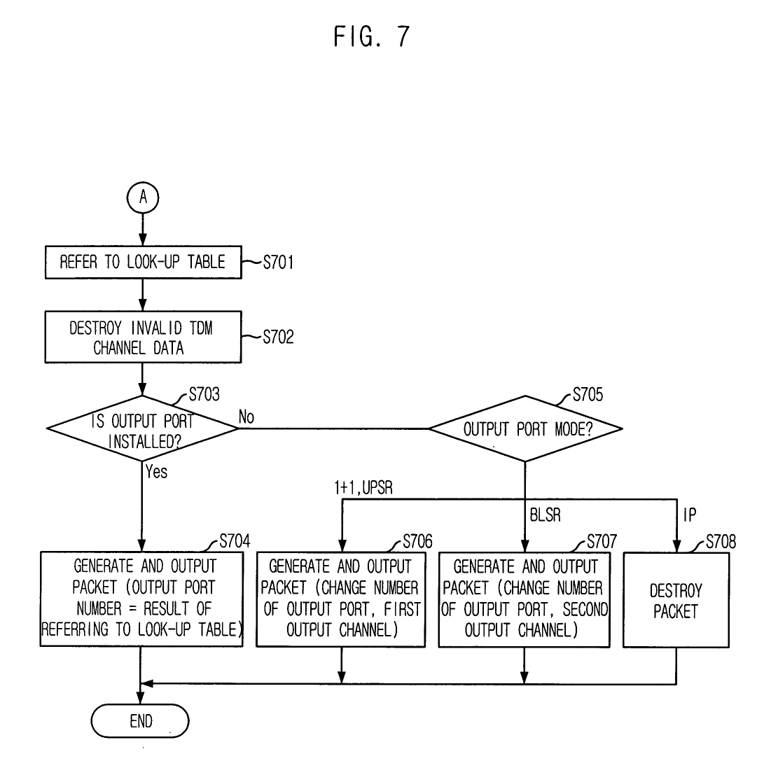

Hereinafter, operations of a packet generator 23 will be explained with reference to FIG. 7.

FIG. 7 is a flowchart showing operations of the packet generator 23 in an integrated switching apparatus supporting a protection switch-over mode of a circuit-switched network in accordance with a preferred embodiment of the present invention.

As shown in FIG. 7, the packet generator 23 receives information about validity 52, an output port 53, a first output channel 54, a second output channel 55 and a priority 56 with reference to the look-up table 22 by using an input TDM channel number in order to convert a received TDM channel data to a packet at step S701. In case of the ‘1+1’ mode or the ‘UPSR’ mode, a representative port number between a pair of output ports is set in the output port number 53 in the look-up table 22. In case of the ‘BLSR’ mode or the ‘IP/Ethernet’ mode, real corresponding output port is set as the output port 53 in the look-up table 22.

The packet generator 23 destroys invalid TDM channel data based on validity information obtained from the look-up table 22 at step S702.

After destroying, the packet generator 23 analyzes information about an output port where corresponding TDM channel data is destined and installation information of output ports collected/distributed by the control/timing unit 600 at step S703.

If the output port is installed at step S703, the packet generator 23 generates a packet recognizable by the fixed length packet switching unit 300 by using the output port number 53, the first output channel 54 and the priority 56 obtained from the look-up table 22 without concerning the mode of the output port, and output the generated packet at step S704.

If the output port is not installed at step S703, an operation mode of the output port is checked at step S706. According to the result of checking, the packet is generated or destroyed.

That is, if the operation mode of the output port is ‘1+1’ or ‘UPSR’ at step S705, the packet generator 23 generates a packet by using an output port number of a mate output port instead of using the output port number obtained from the look-up table 22 and the first output channel 54 as an output channel number, and output the generated packet at step S706. For example, when a pair of output ports for a protection switch-over is formed of an odd number switch port and an (odd number +1) switch port, a representative port number can be estimated as the odd number. If the representative output port is not installed, another output port, i.e., a mate output port, is selected by adding one to the odd number of the output port and the generated packet is transmitted to the mate output port.

If the operation mode of the output is ‘BLSR’ at step S705, the packet generator 23 generates a packet by using an output port number of the mate output port instead of using an output port number obtained from the look-up table 22 and the second output channel 55, and output the generated packet at step S707. For example, if a pair of output ports for a protection switch-over is formed of an odd number switch port and an (odd number +1) switch port and if an output port is not installed, the generated packet is transmitted to another output port, i.e., a mate output port, by obtaining the number of the output port from the look-up table 22, and adding one to the obtained number of the output port when the obtained number is odd, or subtracting one from the obtained number of the output port when the obtained number is even.

Meanwhile, if the mode of the output port is an IP mode at step S705, the packet generator 23 destroys the TDM channel date for minimizing a load of the fixed length packet switching unit 300 at step S708.

Herein, a Hard-wired value or a value set by a system operator through the control/timing unit 600 is used as information about the operation mode and installation according to network connection of the output port.

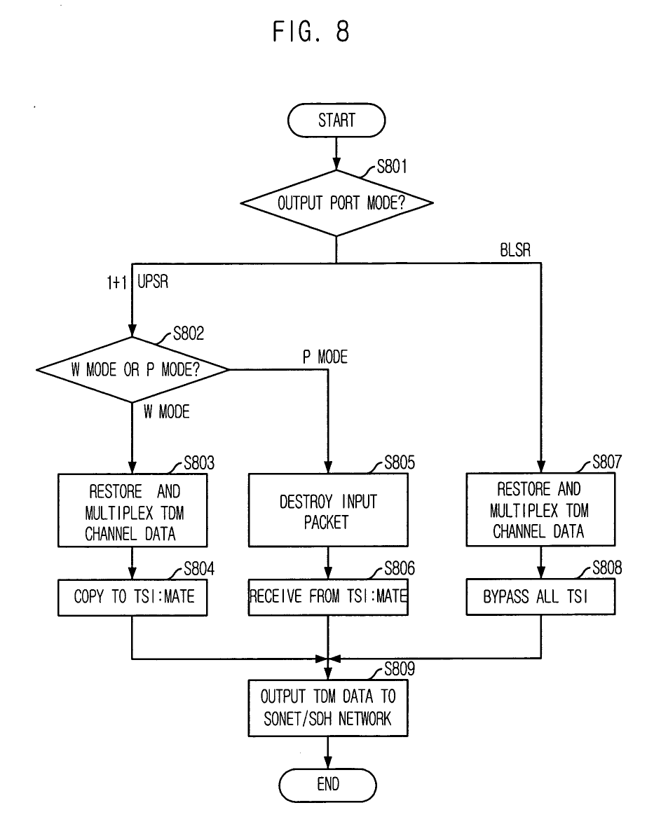

Hereinafter, operations of an output TDM processor will be explained with reference to FIG. 8.

FIG. 8 is a flowchart showing operations of an output TDM processor in an integrated switching apparatus supporting a protection switch-over mode of a circuit-switched network in accordance with a preferred embodiment of the present invention.

As shown FIG. 8, the TDM data restoring unit 41 inspects an operation mode of an own output TDM processor to which the TDM data restoring unit 41 belongs at step S801.

If the operation mode of the own TDM processor is ‘1+1’ or ‘UPSR’ at step S801, the TDM data restoring unit 41 determines whether an own operation mode is a work mode (W mode) or a protect mode (P mode) at step S802.

If the own operation mode is the W mode at step S802, the TDM data restoring unit 41 restores TDM channel data from packets transferred from the fixed length packet switching unit 300, multiplexes the restored TDM channel data, and output the multiplexed TDM channel data to the output TSI processor 42 at step S803. The output TSI processor 42 simultaneously outputs the TDM channel data to both of the SONET/SDH network and the mate output TSI processor at steps S804 and 809.

If the own operation mode is the P mode at step S802,the TDM data restoring unit 41 destroys all packets transferred from the fixed length packet switching unit 300 at step S805. The output TSI processor 42 receives the TDM data from the mate output TSI processor at step S806, and outputs the received TDM data to the SONET/SDH network at step S809. Herein, a W mode or a P mode in ‘UPSR’ operation mode is a mode representing own operation separately from real-connected East ring and West ring. On the other hand, there is no classification (W mode or P mode) according to an operation mode of the TDM data restoring 41 in the ‘BSLR’ operation mode.

Meanwhile, if the operation mode of the own output TDM processor is ‘BLSR’ at step S801, the TDM data restoring unit 41 receives packets from the fixed length packet switching unit 300, restores TDM channel data from the received packets, multiplexes the TDM channel data, and output the multiplexed TDM channel data to the output TSI processor 42 at step S807. The output TSI processor 42 outputs the TDM data to the SONET/SDH network at step S808, and does not output the TDM data to the mate output TSI processor at step S809.

Herein, the operation mode of the output TDM data processor according to the network configuration may be set by using a hard-wired value or by through the control/timing unit 600. Also, the operation mode is set once when initializing the output TDM data processor according to the configuration of the network. In other hand, the W mode or the P mode can be set through the control/timing unit 600 and can be automatically recognized by hardware. Since the output TDM data processor may form a pair with an input TDM data processor physically or logically in another embodiment, W/P mode information may be shared with the input TDM data processor.

Hereinafter, operations of an input IP data processor will be explained in detail. The operations of the input IP data processor are similar to the operations of the input TDM data processor.

At first, the input IP data processor refers to the look-up table 31 by using header information of an externally received IP packet, and obtains information including validity, an output port, a first output channel, a second output channel and a priority in order to generate fixed length packets. Herein, an output port number set in the look-up table 31 is a representative port number between a pair of output ports operated in ‘1+1’ mode or ‘UPSR’ mode. In case of ‘BLSR’ mode or ‘IP/Ethernet’ mode, corresponding output port number must be accurately set in the look-up table rather than the representative number.

The packet converter 32 generates fixed length packets recognizable by the fixed length packet switching unit 300 by using the obtained information from the look-up table 31.

When generating the packet, all of invalid IP/Ethernet data are destroyed by using the validity information obtained from the look-up table 31.

Output port information for valid IP/Ethernet data and installation information of output ports collected/distributed by the control/timing unit 600 are checked.

If the output port is installed, the packet converter 32 generates fixed length packets recognizable by the fixed length packet switching unit 300 by using the obtained information such as the output port number, the first output channel, and the priority from the look-up table 31 regardless of a mode of the output port.

Meanwhile, if the output port is not installed, different types of operations are performed according to an operation mode of the output port.

That is, if a mode of uninstalled output is ‘1+1’ or ‘UPSR’, a packet is generated by using an output port number of a mate output port instead of using an output port number obtained from the look-up table 31 and a first output channel value as the output channel number. For example, when a pair of output TDM ports is formed of an odd number switch port and an (odd number +1) switch port, a representative port number is assumed as the odd number. If the output TDM port is not installed, another output port, i.e., a mate output port, is selected by adding one to the odd number of the output port and the generated packet is transmitted to the mate output port.

If the output port is not installed and a mode of the output port is ‘BLSR’, the packet is generated by using an output port number of the mate output port instead of using the output port number obtained from the look-up table 31 and the second output value as the output channel number. For example, if a pair of output ports is formed of an odd number switch port and an (odd number +1) switch port and if an output port is not installed, the generated packet is transmitted to another output port, i.e., a mate output port, by obtaining the number of the output port from the look-up table 22, and adding one to the obtained number of the output port when the obtained number is odd, or subtracting one from the obtained number of the output port when the obtained number is even.

Furthermore, if the output is not installed and a mode of the output is ‘IP/Ethernet’, all of corresponding IP/Ethernet data is destroyed for minimizing a load of the fixed length packet switching unit 300. Accordingly, no packet. is inputted to the fixed length packet switching unit 300.

Herein, an operation mode of the output TDM data processor according to a network connection may be set by using a hard-wired value or through the control/timing unit 600.

Hereinafter, collection and distribution operations of the control/timing unit 600 will be explained.

At first, the control/timing unit 600 includes a path transmitting/receiving information to each input/output TDM data processor and each input/output IP data processor, and manages the input/output TDM data processors and the input/output IP data processors in a centralized and concentrated way. For example, the control/timing unit 600 collects installation information of output ports from each of the input/output TDM data processors and each of the input/output IP data processors, and evenly distributes the collected installation information to all of the input/output TDM processors and the input/output IP data processors.

Since an operation mode of each input/output TDM data processor and each input/output IP data processor is decided according to a network connected to an entire system, a system operator pre-sets the operation mode. Herein, a value set by the system operator is distributed to all of the input/output TDM data processors and the input/output IP data processors.

Also, the control/timing unit 600 determines a Work mode or a Protect mode according to operation modes of each input/output TDM data processor and the input/output IP data processors and the order of installation, collects the W/P information, and evenly distributes the collected information to all of the input/output TDM data processors and the input/output IP data processors.

Herein, decision process of W/P mode will be explained in detail. For example, a firstly installed input/output TDM data processor in a pair of the input/output TDM data processors is set as a W mode, and a secondly installed input/output TDM data processor is set as a P mode. After setting, the input/output TDM data processor set as the P mode is changed to the W mode when the input/output TDM data processor set as the W mode is uninstalled from the system.

Meanwhile, the installation information, the operation mode and the W/P mode information of each input/output data processor may be transferred through a hardware signal line as a bus type, or transferred by serializing the parallel information to each input/output data processor. For the transfer, the control/timing unit 600 has an additional path for setting a look-up table of each input/output data processor separately from the path for transmitting the installation, the operation mode and the W/P mode information.

Hereinafter, anther embodiment of collecting and distributing information in the control/timing unit 600 will be explained.

That is, the control/timing unit 600 may includes a bus configured with P signal lines, where P is the total number of input/output data processors and equals to the number of ports of the fixed length packet switching unit 300. The P signal lines are occupied by the P input/output data processors for transmitting the installation information.

If an input/output data processor is not installed at one of signal lines, the uninstalled signal line has a default value through a pull-up resistance. When the input/output data processor is installed at a signal line, a predetermined value is applied to the signal line. And, each of the input/output data processors applies an installation signal to a bus signal line of the own port number. Other bus signal lines are used as an input for checking installation states of other input/output data processor.

A W/P mode information transmitting bus may be configured similar to the installation information transmitting bus. For example, each of TDM data processors determines the W/P mode according to the own operation mode, the installation state of the other TDM data processors and the installation state of a mate TDM data processor expressed at the W/P mode transmitting bus, and applies a W/P mode signal to a signal line corresponding to own W/P mode information transmitting bus.

Herein, the firstly installed TDM data processor is operated in the W mode and the secondly installed TDM data process is operated in the P mode in a pair of the TDM data processors. After, the TDM data processor in the W mode is uninstalled, the TDM data processor in the P mode is changed to the W mode.

As described above, TDM data received from the SONET/SDH network is converted to a packet, the packet is switched by a general fixed-length packet switch and the switched packet is re-converted to the TDM data in the integrated switching apparatus according to the present invention. Therefore, the integrated switching apparatus can integrate the conventional SONET/SDH network with the packet network such as the IP network or the Ethernet network while supporting the protection switch-over functions of the SONET/SDH network such as ‘1+1’, ‘UPSR’ and ‘BLSR’.

The present invention contains subject matter related to Korean patent application Nos. 2004-0101841 and 2005-0037755, filed with the Korean patent office on Dec. 6, 2004, and May 4, 2005, respectively, the entire contents of which,being incorporated herein by reference.

While the present invention has been described with respect to certain preferred embodiments, it will be apparent to those skilled in the art that various changes and modifications may be made without departing from the spirit and scope of the invention as defined in the following claims.

What is claimed is:

1. An integrated switching apparatus supporting a protection switch-over function of a circuit-switched network, the integrated switching apparatus comprising:
a plurality of input circuit data processing means for converting externally received circuit data to fixed length packets, and forming a pair in order to output the packet according to the protection switch-over mode;
a plurality of input packet data processing means for converting externally received packet data to fixed length packets, and outputting the packet according to the protection switch-over mode;
a fixed length packet switching means for switching the fixed length packets transferred from the input circuit data processing means and the input packet data processing means to a destination output port;
a plurality of output circuit data processing means for restoring circuit data by converting the fixed length packets transferred from the fixed length packet switching means, and forming a pair for outputting the restored circuit data according a protection switch-over mode;
a plurality of output packet data processing means for restoring and outputting packet data by converting the fixed length packets transferred from the fixed length packet switching means according to a protection switch-over mode; and
a control/timing means for collecting state information from the input circuit data processing means, the input packet data processing means, the fixed length packet switching means, the output circuit data processing means, and the output packet data processing means, and distributing the collected state information in order to switch the externally received circuit data and packet data according to a protection switch-over mode.

2. The integrated switching apparatus as recited in claim 1, wherein each of the input circuit data processing means includes:
an input TSI processing means for performing a time slot interchange (TSI) on externally received circuit data according to a pre-set value, and outputting the processed circuit data classified by each channel;
a look-up table for storing information for generating packets from each channel in response to the control/timing means, installation information about each of the input circuit data processing means and each of the output circuit data processing means, and operation mode information for protection switch-over; and
a packet generation means for generating a fixed length packet by converting channel data outputted from the input TSI processing means according to the installation information of an output port and an operation mode of the output port, which are obtained from the look-up table.

3. The integrated switching apparatus as recited in claim 2, wherein after inspecting a protection switch-over mode of the input TSI processing means, the input TSI processing means:
performs the TSI on the externally received circuit data and outputs the processed circuit data classified by each channel when the operation mode is ‘1+1’ and a ‘work’ mode;
destroys the externally inputted circuit data when the operation mode is ‘1+1’ and ‘protection’ mode;
selectively selects channels from externally received circuit data and circuit data from a mate input TSI processing means, restores full channel data, and outputs the restored channel data classified by each channel when the operation mode is ‘UPSR’ and ‘work’ mode;
bypasses the externally received circuit data to the mate input TSI processing means when the operation mode is ‘UPRS’ and ‘protection’ mode; and
selectively outputs normal channel among the externally received circuit data when the operation mode is ‘BLSR’.

4. The integrated switching apparatus as recited in the claim 2, wherein the look-up table includes:
a validity field for representing whether an input channel number is valid or not;
an output port number field for representing an output switching port number of the fixed length packet switching mean;
a first output channel field for representing a first channel number used when an output port is normal;
a second output channel field for representing a second channel number used alternatively to the first output channel when an output port is changed by the protection switch-over; and
a priority field for representing a relative priority in the fixed length packet switching means.

5. The integrated switching apparatus as recited in claim 4, wherein after checking whether corresponding output port is installed for valid channel data, the packet generating means: generates a fixed length packet by obtaining information about an output port number, a first channel and a priority from the look-up table when the output port is installed; determines an operation mode of an output port when the output port is not installed; generates a packet by using a mate number of an output port obtained from the look-up table as an output port value and a first output channel value if the operation mode is ‘1+1’ or ‘UPSR’; generates a packet by using a mate number of an output port obtained from the look-up table as an output port value and a second output channel value obtained from the look-up table if the operation mode of the output port is ‘BLSR; and destroys the channel data if the operation mode is ‘IP or Ethernet’.

6. The integrated switching apparatus as recited in claim 1, wherein each of the input packet data processors includes:
a lookup table for storing information including validity of a packet, an output port number, an output channel number and a priority; and
a packet converting means for converting an externally received packet data to fixed length packets, and changing an output port number and an output channel number in a header of the fixed length packet according to installation information of corresponding output port and an operation mode of an output port obtained from the look-up table.

7. The integrated switching apparatus as recited in claim 6, wherein the packet converting means destroys invalid packet data among the externally received packet data by using validity information obtained from the look-up table, and converting valid packet data to fixed length packets.

8. The integrated switching apparatus as recited in claim 7, wherein after determining output port information and output port installation information by referring to the look-up table, the packet converting means uses information about an output port number, a first output channel and a priority obtained from the look-up table as an output port number and an output channel number in a header of the converted fixed length packet if the output port is installed, and changes the header of the converted fixed length packet according to an operation mode of an output port if corresponding output port is not installed.

9. The integrated switching apparatus as recited in claim 8, wherein in order to change an output port number of the look-up table and a header of the converted fixed length packet according to an operation mode of an output port, the packet converting means changes an output port number in a header of the converted fixed length packet to a mate port number of corresponding port, changes an output channel number in the header according to a first output channel and a priority information obtained from the look-up table if an operating mode of corresponding output port is ‘1+1’ or ‘UPSR’; changes an output port number in a header of the converted fixed length packet to a mate port number of corresponding port, and changes an output channel number of a header of the converted fixed length packet according to a second output channel and a priority information obtained from the look-up table if the operation mode of an output port is ‘BLSR’; and destroys corresponding channel data if an operation mode is ‘IP/Ethernet’ mode.

10. The integrated switching apparatus as recited in claim 1, wherein each of the output circuit data processing means includes:
a circuit data restoring means for restoring circuit data by converting fixed length packets transferred from the fixed length packet switching means; and
a TSI processing means for performing a time-slot interchange (TSI) on the restored circuit data according to a pre-set value, and outputting the processed circuit data based on a protection switch-over mode classified by each channel.

11. The integrated switching apparatus as recited in claim 10, wherein the circuit data restoring means restores circuit data by converting fixed length packets from the fixed length packet switching means for each channel, destroys a fixed length packet having errors and transfers restored circuit data without errors to the output TSI processing means.

12. The integrated switching apparatus as recited in the claim 11, wherein the circuit data restoring means restores channel data by converting fixed length packets transferred from the fixed length packet switching means if an operation of the output circuit data processing means is ‘1+1’ or ‘UPSR’, and a ‘Work’ mode; destroys all of fixed length packet transferred from the fixed length packet switching means if the operation mode of the output circuit data processing means is ‘1+1’ or ‘UPSR’, and a ‘Protect’ mode; and restores channel data by converting fixed length packets transferred from the fixed length packet switching means if the operation mode of the output circuit data processing means is ‘BLSR’.

13. The integrated switching apparatus as recited in claim 10, wherein the output TSI processing means: performs a time-slot interchange (TSI) on the restored circuit data according to a predetermined value, and simultaneously outputs the processed circuit data to both of a connected network and a mate output circuit data processing means of corresponding output port if an operation mode of the output circuit data processing means is ‘1+1’ or ‘USPR’, and a ‘Work’ mode; performs the TSI on the circuit data received from the mate output circuit data processor, and outputs the processed circuit data to the connected network if the operation mode of the output circuit data processing means is ‘1+1’ or ‘UPSR’ and ‘Protect mode’; and performs the TSI on the restored circuit data according to a predetermined value if the operation mode of the output circuit data processor is ‘BLSR’.

14. The integrated switching apparatus as recited in claim 1, wherein the control/timing means collects installation information of each output port, operation mode information and ‘Work/Protect’ information, and evenly distributes the collected information to each of the input/output circuit data processing means and the input/output packet data processing means.

15. The integrated switching apparatus as recited in claim 14, wherein the control/timing means determines a ‘work’mode or a ‘protect’ mode according to operation modes of the input/output circuit data processing means and the input/output packet data processing means and it's installation order, collects entire ‘work’/‘protect’ mode information, and evenly distributes the collected information to all of the input/output circuit data processing means and the input/output packet data processing means.

16. An integrated switching method supporting a protection switch-over mode of a circuit-switched network, the integrated switching method comprising the steps of:
a) converting input circuit data to fixed length packets;
b) converting input packet data to fixed length packets;
c) switching the converted fixed length packets to a destination output port based on a protection switch-over mode;
d) restoring circuit data of a connected network by converting the switched fixed length packets and outputting the restored circuit data based on a protection switch-over mode; and
e) restoring packet data of a connected network by converting the switched fixed length packets and outputting the restored packet data based on a protection switch-over mode.

17. The integrated switching method as recited in claim 16, wherein the step a) includes the steps of:
a-1) performing a time-slot interchange (TSI) on input circuit data according to a predetermined value, and outputting the processed circuit data classified by each channel;
a-2) obtaining installation information of an output port and operation mode information of an output port for each channel by referring to a look-up table; and
a-3) generating fixed length packets from the processed circuit data according to the installation information and the operation mode of the output port obtained from the look-up table.

18. The integrated switching method as recited in claim 16, wherein the step b) includes the steps of:
b-1) obtaining installation information of corresponding output port and an output channel number from a look-up table;
b-2) converting input packet data to fixed length packets; and
b-3) changing an output port number and an output channel number in a header of the converted fixed length packet according to installation information and an output channel number of corresponding output port obtained from the look-up table.

19. The integrated switching method as recited in claim 16, wherein the step d) includes the steps of:
d-1) restoring circuit data of a connected network by converting the switched fixed length packets; and
d-2) performing a time-slot interchange (TSI) on the restored circuit data according to a predetermined value, and outputting the processed circuit data according to each channel based on a protection switch-over mode.
